(19) United States
(12) Patent Application Publication
(10) Pub. No.: US 2025/0249363 A1
(43) Pub. Date: Aug. 7, 2025

(54) INTERACTION METHOD, MEDIUM, AND ELECTRONIC DEVICE

(71) Applicant: Beijing Zitiao Network Technology Co., Ltd., Beijing (CN)

(72) Inventors: Denglin JI, Beijing (CN); Li ZHONG, Beijing (CN)

(21) Appl. No.: 18/979,423

(22) Filed: Dec. 12, 2024

(30) Foreign Application Priority Data
Feb. 4, 2024 (CN) 202410162750.2

(51) Int. Cl. A63F 13/55; A63F 13/52; G06T 13/40; G06T 17/00

(52) U.S. Cl. CPC A63F 13/55; A63F 13/52; G06T 13/40; G06T 17/00

(57) ABSTRACT

An interaction method, a medium, and an electronic device are provided. The method includes: displaying a virtual scene interface, in which the virtual scene interface includes at least one virtual character, actions of the virtual character are controlled based on a basic plan, the basic plan includes a basic instruction sequence corresponding to the virtual character; in response to an interactive operation of a user on a target virtual character in the virtual scene interface, acquiring interactive information corresponding to the interactive operation; based on the interactive information, determining a target instruction sequence corresponding to the target virtual character; according to the interactive information and character information corresponding to the target virtual character, generating an interactive text corresponding to the target virtual character; and controlling the target virtual character to act based on the basic plan and the target instruction sequence, and outputting the interactive text.

### CROSS-REFERENCE TO RELATED APPLICATION

This application claims the priority of Chinese Patent Application No. 202410162750.2 filed on Feb. 4, 2024, the disclosure of which is incorporated by reference herein in its entirety as part of the present application.

### TECHNICAL FIELD

Embodiments of the present disclosure relates to the field of computer technologies, and in particular, to an interaction method, a medium, and an electronic device.

### BACKGROUND

An intelligent non-player character (NPC) mainly focuses on conversation intelligence. For example, when a player character inputs a text, the NPC can make a corresponding reply based on the input text, thereby implementing a conversation with the player character. In the related art, there are usually multiple NPCs in a virtual scene, such as a game scene, and the multiple NPCs can act in the game scene based on a preset plan. However, in this process, an action plan of the NPC is usually generated in advance, and the action of the NPC is controlled based on the action plan, so that the NPC can implement a performance process in the virtual scene. In this process, the player character cannot interact with the NPC.

### SUMMARY

This Summary is provided to introduce concepts in a simplified form, the concepts are described in detail in the following Detailed Description section. This Summary section is not intended to identify key features or essential features of the claimed technical solution, nor is it intended to be used to limit the scope of the claimed technical solution.

In a first aspect, the embodiments of the present disclosure provides an interaction method, the method includes:
displaying a virtual scene interface, in which the virtual scene interface includes at least one virtual character, actions of the virtual character are controlled based on a basic plan, the basic plan includes a basic instruction sequence corresponding to the virtual character;
in response to an interactive operation of a user on a target virtual character in the virtual scene interface, acquiring interactive information corresponding to the interactive operation;
based on the interactive information, determining a target instruction sequence corresponding to the target virtual character;
according to the interactive information and character information corresponding to the target virtual character, generating an interactive text corresponding to the target virtual character; and
controlling the target virtual character to act based on the basic plan and the target instruction sequence, and outputting the interactive text.

In a second aspect, the embodiments of the present disclosure provide an interaction apparatus, the apparatus includes:
a display module, configured to display a virtual scene interface, in which the virtual scene interface includes at least one virtual character, actions of the virtual character are controlled based on a basic plan, the basic plan includes a basic instruction sequence corresponding to the virtual character;
an obtaining module, configured to, in response to an interactive operation of a user on a target virtual character in the virtual scene interface, acquire interactive information corresponding to the interactive operation;
a first determination module, configured to, based on the interactive information, determine a target instruction sequence corresponding to the target virtual character;
a first generation module, configured to, according to the interactive information and character information corresponding to the target virtual character, generate an interactive text corresponding to the target virtual character; and
an interaction module, configured to control the target virtual character to act based on the basic plan and the target instruction sequence, and output the interactive text.

In a third aspect, the embodiments of the present disclosure provide a computer-readable medium having a computer program stored thereon, where the program, when executed by a processing apparatus, implements the steps of the method according to the first aspect.

In a fourth aspect, the embodiments of the present disclosure provides an electronic device, which includes:
a storage apparatus having a computer program stored thereon; and
a processing apparatus configured to execute the computer program in the storage apparatus to implement the steps of the method according to the first aspect.

### BRIEF DESCRIPTION OF DRAWINGS

The above and other features, advantages and aspects of various embodiments of the present disclosure will become more apparent when taken in conjunction with the drawings and with reference to the following detailed description. Throughout the drawings, the same or similar reference numerals refer to the same or similar elements. It should be understood that the drawings are schematic and the components and elements are not necessarily drawn to scale. In the drawings:

FIG. 1 is a flowchart of an interaction method according to at least one embodiment of the present disclosure.

FIG. 2 is a schematic diagram of an interaction flow according to at least one embodiment of the present disclosure.

FIG. 3 is a block diagram of an interaction apparatus according to at least one embodiment of the present disclosure.

FIG. 4 illustrates a schematic structural diagram of an electronic device suitable for implementing at least one embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between multiple apparatuses in the implementations of the present disclosure are only for illustrative purposes, and are not used to limit the scope of these messages or information.

It can be understood that before the technical solution disclosed in each embodiment of the present disclosure is used, the user should be informed of the type, use scope, use scenario, and the like of the personal information involved in the present disclosure in an appropriate manner in accordance with relevant laws and regulations, and the user's authorization should be obtained.

For example, when a user's active request is received, prompt information is sent to the user to explicitly prompt the user that the operation requested by the user will need to obtain and use the user's personal information. Therefore, the user can independently choose whether to provide personal information to software or hardware such as an electronic device, an application, a server, or a storage medium that executes the operation of the technical solution of the present disclosure based on the prompt information.

As an optional but non-limiting implementation, in response to receiving the user's active request, for example, the prompt information may be sent to the user in a pop-up window, and the prompt information may be presented in the pop-up window in text. In addition, the pop-up window may also carry a selection control for the user to select “agree” or “disagree” to provide personal information to the electronic device.

It can be understood that the above notification and user authorization obtaining process are only illustrative and do not limit the implementations of the present disclosure. Other methods that comply with relevant laws and regulations may also be applied to the implementations of the present disclosure.

In addition, it can be understood that the data involved in this technical solution (including but not limited to the data itself, the acquisition or use of data) should comply with the requirements of corresponding laws and regulations and related regulations.

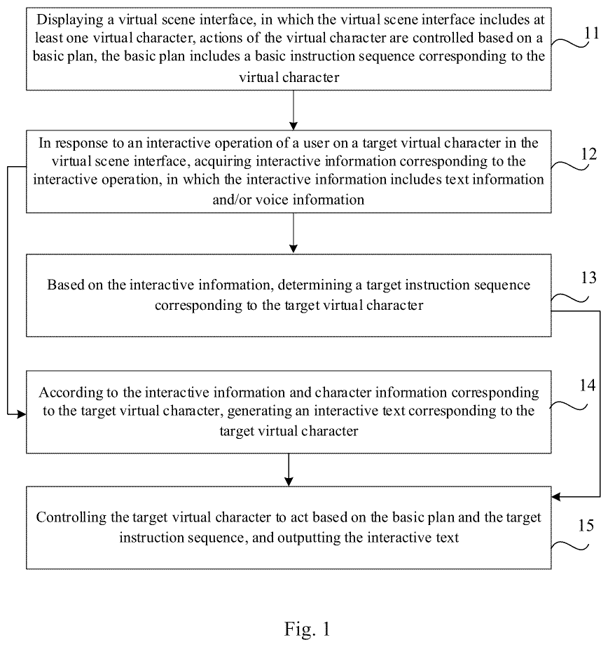

FIG. 1 is a flowchart of an interaction method provided according to at least one embodiment of the present disclosure. As shown in FIG. 1, the method may include the following steps.

In step 11: displaying a virtual scene interface, in which the virtual scene interface includes at least one virtual character, actions of the virtual character are controlled based on a basic plan, the basic plan includes a basic instruction sequence corresponding to the virtual character.

The virtual scene interface may be an environmental interface where the virtual character is located, which is rendered in a computer, the environmental interface is, for example, a game scene interface. The virtual character may be a non-player character, i.e., an NPC, which can be controlled by a computer, and one or more virtual characters can be set in the virtual scene in a pre-configured manner.

In this embodiment, the basic plan corresponding to the virtual character in a next plan cycle can be generated offline. The plan cycle corresponding to the basic plan can be set based on an actual application scenario. For example, the plan cycle can be set to 1 day, which is used to represent 1 day in the virtual time in the virtual environment. That is, the basic plan can represent the plan corresponding to the virtual character in its corresponding 1 day of virtual time, such as what plans or actions can be performed, etc., to control the action of the virtual character, so that the virtual character in the virtual scene interface can perform the action according to the basic plan.

In step 12: in response to an interactive operation of a user on a target virtual character in the virtual scene interface, acquiring interactive information corresponding to the interactive operation, in which the interactive information includes text information and/or voice information.

As an example, when the user does not participate in the interaction, the virtual character can be controlled in the virtual scene interface according to its corresponding basic plan. For example, when the virtual character VA is a bakery clerk, based on the basic plan, the virtual character VA can be controlled to perform actions such as cleaning and making bread in the bakery.

In the embodiments of the present disclosure, the user can control the corresponding player character to act in the virtual scene to implement interaction with other player characters or virtual characters in the virtual scene. For example, when the user U1 controls the player character B1 to approach the virtual character VA, for example, when the distance between the player character B1 and the virtual character VA is less than a distance threshold, an interactive button can be triggered to be displayed corresponding to the virtual character VA, and the user can click the interactive button to trigger an interactive operation with the virtual character VA, then the virtual character VA can be used as the target virtual character. For example, the user can input a text “Can you help me get the strawberry cake?”, and the virtual character VA can respond to the input of the user.

In step 13: based on the interactive information, determining a target instruction sequence corresponding to the target virtual character.

The interactive information may include an instruction for the target virtual character. As in the above example, the text input by the user may include an instruction to instruct the target virtual character to take the strawberry cake, which can drive the target virtual character VA to move to the cake shelf, take the strawberry cake and return. In this step, the interactive information can be identified to determine the indication information included therein, and further obtain the target instruction sequence corresponding to the indication information.

In step 14: according to the interactive information and character information corresponding to the target virtual character, generating an interactive text corresponding to the target virtual character.

The interactive text is a text for the target virtual character to interact with the user, that is, a reply to the input of the user. The character information may be information for describing the target virtual character, for example, it may include character setup information and memory information of the target virtual character. For example, the character setup information may include a setting of the personality, the character relationship, etc. of the target virtual character, and the memory information may represent the experiences of the target virtual character within a historical period of time, such as the historical conversations of the target virtual character, the historical events performed by the target virtual character, etc. In this step, the interactive text is generated based on the character information and the interactive information, which can further improve the matching degree between the interactive text and the target virtual character, and at the same time improve the personification level of the interactive text.

In step 15: controlling the target virtual character to act based on the basic plan and the target instruction sequence, and outputting the interactive text.

As an example, an instruction to be executed currently can be determined from the basic plan and the target instruction sequence, so that the target virtual character is controlled to act based on the instruction to be executed. When the target instruction sequence is the instruction to be executed currently, the target virtual character can be controlled to act based on the target instruction sequence. For example, the virtual character VA can be controlled to move to the cake shelf to take the cake.

As an example, outputting the interactive text can be displaying the interactive text at a conversation position corresponding to the target virtual character in the form of a dialogue bubble, then the user can view the interactive text displayed in the interface to implement interaction with the target virtual character. As another example, outputting the interactive text can be outputting the interactive text in the form of voice. For example, a voice corresponding to the interactive text can be generated based on the interactive text and a voice synthesis technology, and then the voice can be output to implement voice interaction with the user. Optionally, the interactive text and the voice can be output together, and a specific output manner can be set based on an actual application scenario, which is not limited in the present disclosure.

Therefore, with the above technical solutions, in a real-time process of controlling the virtual character based on the basic plan, the user can interact with the virtual character in a way of conversation, so that the user can give an instruction through the conversation to interfere with the real-time behavior of the virtual character, thereby implementing the conversation and behavior interaction between the user and the virtual character, and ensuring the consistency between the conversation and the behavior of the virtual character. Therefore, in the process of controlling the virtual character to implement the performance process in the virtual scene, the player character can participate in the interaction with the virtual character in real time, which not only can improve the accuracy of controlling the virtual character, but also can improve the personification level of displaying the virtual character in the virtual scene, thereby improving the diversity of user interaction and the interaction experience.

In a possible embodiment, based on the interactive information, the determining the target instruction sequence corresponding to the target virtual character may include:

identifying the interactive information and determining whether the interactive information includes instruction information.

As an example, intention recognition can be performed on the interactive information, and based on the result of the intention recognition, it is determined whether the interactive information includes an intention to instruct the target virtual character to act. When the intention is included, it means that the interactive information includes the instruction information, and information representing the intention is used as the instruction information. The intention recognition (or Intent Recognition) is a natural language processing technology used to determine the intention or purpose of the user when having a conversation with the computer, which can be implemented based on a general method in the art and will not be repeated here.

When the interactive information includes the instruction information, the target instruction sequence is determined based on the instruction information, a candidate virtual object in a target region where the target virtual character is located currently, and a candidate instruction corresponding to the candidate virtual object.

When the interactive information includes the instruction information, a corresponding instruction can be further generated based on the instruction information and environmental information corresponding to the target virtual character.

As an example, the candidate instruction corresponding to the target virtual object may represent various instructions that can be executed by the target virtual object, which can be configured in a pre-configured manner in an instruction library. For example, APIs corresponding to various instructions can be pre-configured. For example, a go to instruction can be configured to control the target virtual object to move to a certain position, and a use instruction can be configured to control the target virtual object to use a certain item.

The candidate virtual object in the target region where the target virtual character is located currently may be used to represent an object that can currently interact with the target virtual character, which may include other virtual characters and items in the virtual environment.

As an example, the instruction information can be matched with the candidate instruction to determine a matching instruction that implements the instruction information from the candidate instruction. When there is a matching instruction, based on the candidate virtual object, it is further determined whether a parameter required to execute the matching instruction is satisfied. When it is determined that the parameter required to execute the matching instruction is satisfied, a target instruction can be generated based on the matching instruction and the parameter corresponding to the matching instruction, so as to ensure the validity and legality of the generated target instruction. Then the target instruction can be spliced based on the time sequence to obtain the target instruction sequence.

As another example, a prompt can be constructed to generate an instruction based on a large language model (LLM). In the LLM model, the prompt can be constructed in a way of in-context learning (ICL) and chain-of-thought (CoT), so that the interactive information can correspond to the candidate virtual object, and then a sequence of instructions can be generated from the candidate instructions as the target instruction sequence.

Therefore, with the above technical solutions, the interactive information input by the user can be identified in real time, so that the corresponding instruction sequence can be quickly and accurately generated when the interactive information includes the instruction intention, so that the target virtual character can be controlled to act based on the target instruction sequence, the virtual character can receive the instruction from the player in real time to implement the interaction, and the user can implement the behavior interference to the virtual character through the interaction, thereby improving the diversity and real-time performance of the interaction with the virtual character.

In a possible embodiment, the basic plan of the target virtual character may be generated by:
acquiring character setup information of the target virtual character, and based on the character setup information and a candidate position list corresponding to the target virtual character, generating various to-be-processed plans corresponding to the target virtual character.

As an example, the character setup information includes basic setup information and immediate setup information, the basic setup information is used to represent attribute information of the target virtual character that is kept unchanged during an interaction process, and the immediate setup information is used to represent attribute information of the target virtual character that changes during an interaction process.

For example, the basic setup information may include one or more from a group consisting of identity description information, personality information, character target information, and character relationship information. The identity description information is used to represent the identity setting of the virtual character, such as information such as occupation, in-game background, and family members. The personality information is used to represent the personality of the virtual character, and the personality information enables the same virtual character to maintain the same persona in different scenarios or when having conversations with different characters. The character target information is used to represent a specific target of the virtual character. For example, the virtual character may have a specific identity and functional positioning. For example, when the identity of the NPC is an ice cream shop owner, its character target may be to take the initiative to say hello to the player and then sell the items in the ice cream shop to the player after the player enters the ice cream shop. Based on this character target, the behavior of the virtual character can be planned more accurately. The character relationship can be used to represent the relationship between different virtual characters. For example, when the virtual characters VA1 and VA2 are in a husband-wife relationship, it can affect the behavior interaction and plot generation between different NPCs, and at the same time may also affect the relationship between the NPC and the player through social networks.

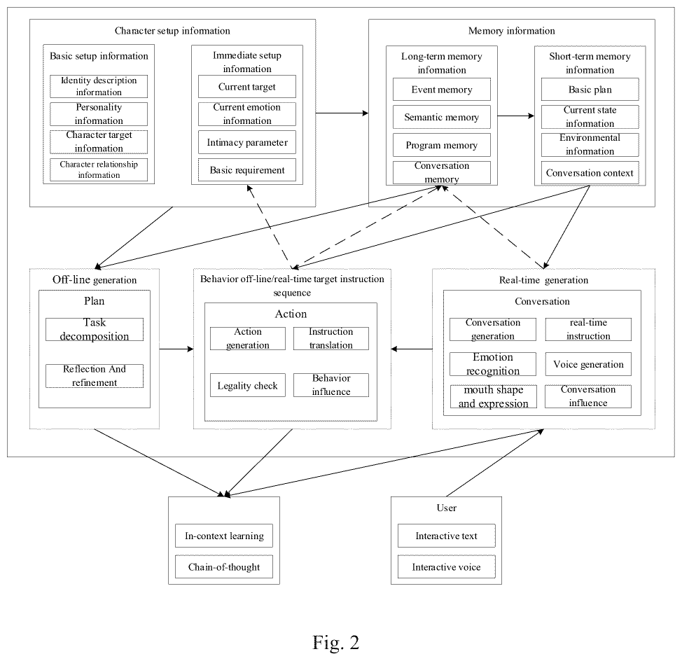

For example, the immediate setup information may include one or more from a group consisting of a current target, current emotion information, an intimacy parameter, and a basic requirement. The current target may be used to represent an immediate target of the virtual character, such as what is the current plan, it may be a null value when the basic plan is determined, and when the virtual character is controlled to perform an operation based on the basic plan, it may represent a current to-be-executed plan of the virtual character in the basic plan, which may have an impact on a theme of a content generated by the virtual character in a current round. The current emotion information may be used to represent a current emotion of the virtual character. When the virtual character is controlled to perform interaction, an emotion of an interactive text output by the virtual character in a previous round may be used as an emotion in a current round, that is, the current emotion may affect a style of content generated by the virtual character in the current round. The intimacy parameter may be used to represent an intimate relationship established between the virtual character and other characters (NPC/player character), which may be established through conversation or behavior. For example, in a conversation scenario, the intimacy parameter may be dynamically adjusted in combination with a conversation round and an emotion tendency of the conversation content. For example, in a behavior scenario, behaviors such as giving away items can be quantified to dynamically adjust the intimacy parameter. As an example, different intimate relationships may affect the plot/behavior generation. The basic requirement may be used to represent a basic state of the virtual character. For example, it may combine the style corresponding to the virtual scene and a plot background requirement to perform quantified settings on some basic requirement states of the virtual character, such as requirement values such as health, energy, social, entertainment, and satiety, so that the behavior of the virtual character can be more personified, for example, to eat food to overcome hunger, and to perform social activities to relieve loneliness, etc. The character setup information is shown in FIG. 2.

In this embodiment, for any virtual character, a corresponding prompt can be constructed based on the character setup information of the virtual character and a candidate position list corresponding to the target virtual character, so that various to-be-processed plans corresponding to the target virtual character are generated based on the LLM model. For example, the output plan format can be given in the form of an example in the prompt, for example:

Example for plan:

Here is Jack's plan from now at 7:45:
{“Location”: “restaurant”, “Plan”: “Go to restaurant for breakfast”, “From”: “7:45”, “To”: “8:35”}
{“Location”: “school”, “Plan”: “Go to school for study”, “From”: “8:35”, “To”: “12:00”}
. . .
{“Location”: “home”, “Plan”: “Go back home to play CSGO”, “From”: “16:35”, “To”: “22:35”}.

The to-be-processed plan may be a coarse-grained plan, so that the generated to-be-processed plan is consistent with the persona and requirement target of the virtual character.

Then, the memory information of the target virtual character is acquired, and based on the memory information and the to-be-processed plans, a behavior of the target virtual character corresponding to the each of the to-be-processed plans is generated.

When the to-be-processed plan of the virtual character is determined, finer-grained task decomposition can be performed for each to-be-processed plan, so as to obtain the behavior Action corresponding to the target virtual character when executing the to-be-processed plan.

As an example, in this step, behavior generation can be further performed in combination with the memory information of the virtual character, so that the behavior generation for the to-be-processed task is consistent with the historical memory of the virtual character, thereby ensuring the consistency of the behavior of the virtual character and improving the personification level of the virtual character.

The memory information may include long-term memory information and short-term memory information. The long-term memory information enables the virtual character to have the ability to store and retrieve historical information for a long time, which can be implemented by storing in an external carrier and performing rapid retrieval. When retrieving, it is usually based on dimensions such as relevance, importance, and time, and for relatively long-term memory, it is summarized through a regular Reflection mechanism. The Reflection mechanism is regarded as the key to dynamic languages. The reflection mechanism allows the program to obtain the internal information of any class by means of the Reflection API during the execution period, and can directly operate the internal attributes and methods of any object. It can be summarized based on a general implementation in the art, which is not limited in the present disclosure.

As an example, the long-term memory information may include at least one from a group consisting of event memory, semantic memory, program memory, and conversation memory. The event memory may be used to represent the memory data of the events that the virtual character has done and seen. The semantic memory may be used to represent the semantic knowledge memory of the virtual character to the game world, such as information of world view settings, hobbies, birthdays, and character relationships of other virtual characters, which may be obtained by summarizing the character setup information of the virtual character, and may also be obtained by summarizing historical conversation information of the virtual character. The program memory may be used to represent a unique routine behavior of the virtual character, such as taking a walk after a meal, police patrol, etc., which may be obtained by summarizing the behavior of the virtual character through Reflection. The conversation memory may be used to represent historical conversation information corresponding to the virtual character, which may include conversation memories between virtual characters, and conversation memories between virtual characters and player characters.

As an example, the short-term memory information may include at least one from a group consisting of a basic plan, current state information, environmental information of a currently located environment, and a conversation context corresponding to the user, which may be used for conversation generation of the current round of decision-making of the virtual character. The basic plan may be used to represent various behaviors of the virtual character in its plan cycle. Therefore, when making a decision in the current round, such as generating a conversation, combining this basic plan can make a clear perception of the virtual character's own plan, and ensure the consistency between the conversation content and the virtual character's own behavior. The current state information may be used to represent a state of the virtual character when performing real-time interaction, such as an action that the virtual character is currently doing. The environmental information of the currently located environment may be used to represent the environmental information of the environment where the virtual character is located during real-time interaction, such as the game time and the virtual object in the environment. The virtual object may be, for example, items and buildings. Since the surrounding environment may change during the interaction process, combining the surrounding environment during task decomposition can also make the generated behavior adapt to the changes in the environment. The conversation context corresponding to the user may include a conversation context when the virtual character is interacting, which includes not only the context of the real conversation content, but also the context-related information retrieved from the long-term memory information. The memory information is shown in FIG. 2.

In this step, a prompt can be constructed based on the memory information and the to-be-processed plan, so as to generate a corresponding behavior Action based on the LLM. The memory information may include some or all of the above-mentioned memories, and a range of selected memories may be pre-set based on an actual application scenario, for example, the M recent pieces of memory information. As an example, the prompt may also include character setup information, so as to further improve the accuracy of the generated behavior and the consistency of the persona of the virtual character.

For example, when constructing the prompt, the format of the output behavior can be constrained by way of example, as follows:
Example for John's actions for plan “waking up and complete the morning routine”, starting from 7:15 to 8: 45 (total duration in minutes: 90):
{“Action”: “stretching and meditating”, “Location”: “double_sofa”, “From”: “7:15”, “To”: “7:25”, “Duration”: 10} (Duration in minutes: 10, minutes left: 80)
{“Action”: “grab breads from refrigerator”, “Location”: “refrigerator”, “From”: “7:25”, “To”: “7:30”, “Duration”: 5} (Duration in minutes: 5, minutes left: 75)
. . .
{“Action”: “have a cup of coffee”, “Location”: “coffee_table”, “From”: “8:35”, “To”: “8:45”, “Duration”: 10} (Duration in minutes: 10, minutes left: 0)

Therefore, the basic plan corresponding to the virtual character can be generated based on the LLM according to the character setup information and the memory information. In this process, the task decomposition is performed in a hierarchical manner. The coarse-grained to-be-processed plan is generated first, and then the fine-grained semantic behavior Action, that is, the behavior represented at the semantic level, is generated. Therefore, the accuracy and rationality of the generated basic plan can be ensured by this hierarchical manner, thereby ensuring the rationality and smoothness of the behavior and action of the virtual character.

As an example, the generated semantic behavior Action can be refined and reflected through Reflection to extract high-level information and add it to the memory information. Based on the reflection mechanism, the virtual character can periodically perform self-criticism and self-reflection on past behaviors, extract high-level information from them, and add the information to the long-term memory information, thereby providing data reference for subsequent basic plans. Reflection and refinement can help the virtual character improve its intelligence and adaptability, thereby improving the accuracy of controlling the virtual character.

Then, an instruction sequence corresponding to each of the behaviors can be generated, and the instruction sequence is spliced based on time information corresponding to the behavior to obtain the basic plan. For example, instruction sequences corresponding the behaviors are spliced based on time information to obtain the basic plan.

As an example, in this step, an action can be generated according to the semantic behavior action generated in the previous step. For each behavior, an action sequence that can be completed can be generated in combination with the virtual object in the virtual scene first, and then the action sequence is translated into an instruction sequence that can be executed by the virtual object. The behavior and action of the virtual character in the game scene are usually completed by the combined call of the underlying API. Some instructions that can be freely combined to complete specific actions can be developed based on the underlying API, so as to translate the action sequence into an instruction sequence that can be executed by the program. The instruction translation can be implemented through the LLM model in combination with the candidate instructions executable by the virtual character.

Then, in order to ensure the executability of the instruction sequence, legality check can be performed on it. Since the generation of the LLM model is uncontrollable, there may be illegal instructions in the result of the instruction translation, and the wrong instruction will cause the behavior of the virtual character to be wrong. Therefore, in this embodiment, the legality check can be further performed in combination with the virtual object in the virtual scene. For example, it can be determined, based on the virtual object, whether the instruction parameter required by each instruction is satisfied. When it is satisfied, it means that the legality check is passed, thereby ensuring the legality and consistency of the behavior of the virtual character. After the legality check is passed, the instruction sequence corresponding to the behavior executed by the virtual character can be generated, and the basic plan corresponding to the virtual character, that is, a list of specific behaviors of the virtual character on that day, can be obtained by splicing the instruction sequences corresponding to the respective behaviors. Optionally, the immediate setup information and the memory information can be updated based on the basic plan. As shown by the dotted line in FIG. 2, the behavior can further update the character setup information and the memory information.

As an example, controlling the virtual character to execute the instruction in the target instruction sequence may be driving, by the computer, the virtual character to complete the instruction. The real-time instruction shown in FIG. 2 is used to represent the generation of the target instruction sequence. In this embodiment, an instruction executor can be configured based on an API exposed in an application corresponding to the virtual scene. The instruction executor can be mounted in the application as a global service to be executed by a program of the application.

Therefore, with the above technical solutions, the task decomposition can be performed in a hierarchical manner. The coarse-grained to-be-processed plan is generated first, and then the fine-grained semantic behavior Action is generated, so that the accuracy and rationality of the basic plan can be ensured, thereby improving the accuracy of controlling the virtual character. Further, the behavior can be translated into an instruction sequence that can be executed by the instruction executor, thereby improving the smoothness of controlling the virtual character.

In a possible embodiment, the immediate setup information of the virtual character may include numerical settings such as an intimacy parameter and a basic requirement state. Generally, the behavior of the virtual character can affect the numerical changes of these settings. Therefore, after the corresponding behavior is generated, the updated values corresponding to the intimacy parameter and the basic requirement can be further obtained through the behavior, and the intimacy parameter and the basic requirement are updated. As shown in the behavior influence part in FIG. 2, the behavior influence part may include the influence of the behavior on the intimacy parameter. Among them, influence rules of different behaviors on the intimacy parameter and the basic requirement can be pre-configured. For example, the intimacy can be adjusted based on the number of times of giving away items and the level of the item in the behavior of giving away items. The influence rules can be pre-set based on an actual application scenario, which is not limited in the present disclosure.

In a possible embodiment, an exemplary implementation of controlling the target virtual character to act based on the basic plan and the target instruction sequence and outputting the interactive text may include:
outputting the interactive text and determining a priority of a current instruction executed by the target virtual character in the basic plan and a priority of the target instruction sequence.

The interactive text may be output in the form of a dialogue bubble or voice, which will not be repeated here.

As an example, the priorities of different instructions can be set in advance. For example, the priority of the target instruction sequence may be set to the highest priority.

When the priority of the target instruction sequence is higher than the priority of the current instruction, the target virtual character is controlled to execute an instruction in the target instruction sequence; and
after the instruction in the target instruction sequence is completed, the target virtual character is controlled to execute the current instruction in the basic plan and an instruction after the current instruction.

In this embodiment, after the target instruction sequence is determined, the current instruction in the basic plan can be paused, and the instructions in the target instruction sequence can be executed in turn, so that the player can trigger the generation of the instruction in the form of a conversation interaction to interfere with the real-time behavior of the virtual character, and the target virtual character can respond based on the interactive input of the user. After the instruction in the target instruction sequence is completed, the target virtual character can be controlled to continue to execute the current instruction in the basic plan and the instruction after the current instruction, that is, in this embodiment, it is not necessary to regenerate the basic plan, and it is only to postpone the execution of the current instruction in the basic plan and the instruction after the current instruction, which can not only implement the interference of the user's conversation to the virtual character's instruction, but also ensure the accuracy of the virtual character's execution of its basic plan, thereby ensuring the accuracy of controlling the virtual character.

In a possible embodiment, an exemplary implementation of controlling the target virtual character to act based on the basic plan and the target instruction sequence and outputting the interactive text may include:
outputting the interactive text and controlling the target virtual character to execute a target instruction in the target instruction sequence. The interactive text may be output in the form of a dialogue bubble or voice, which will not be repeated here.
based on the character setup information and the memory information of the target virtual character, generating a new basic plan corresponding to the target virtual character; and after the instruction in the target instruction sequence is completed, controlling the target virtual character to execute an instruction in the new basic plan.

In this embodiment, after the target instruction sequence is determined, the target virtual character can be directly controlled to execute the respective instructions therein. In this case, the basic plan corresponding to the target virtual character can be regenerated. The method for generating the basic plan has been described in detail above, and will not be repeated here.

Therefore, in this embodiment, the basic plan of the virtual character can be regenerated after the user interferes with the instruction of the virtual character based on the conversation, so that after the instruction in the target instruction sequence is completed, the target virtual character can be controlled to act based on the newly generated basic plan, thereby ensuring the consistency and continuity of the actions performed by the virtual character after the user interferes with the actions of the virtual character, and further improving the accuracy of controlling the virtual character.

As another example, it takes time to regenerate the basic plan of the virtual character. When the new basic plan has not been obtained after the instruction in the target instruction sequence is completed, at this case, the target virtual character can be controlled to execute a default instruction, and after it is determined that the new basic plan is generated, the target virtual character is controlled to execute the instruction in the new basic plan. For example, the default instruction may be a movement instruction, that is, the virtual character can be controlled to take a walk in the virtual environment, so as to prevent the virtual character from being static to improve the real-time performance of interacting with the user, so that the displaying actions of the virtual character in the virtual environment are coherent, thereby improving the user experience.

In a possible embodiment, the character information corresponding to the target virtual character includes character setup information and memory information of the target virtual character; and
accordingly, according to the interactive information and the character information corresponding to the target virtual character, generating the interactive text corresponding to the target virtual character may include:
based on the character setup information, the interactive information, and the memory information, generating the interactive text corresponding to the target virtual character, in which the memory information includes event information and conversation information of the target virtual character within a historical period of time. For example, the conversation generation in FIG. 2 is used to generate the interactive text.

The specific content of the character setup information and the memory information has been described in detail above, and will not be repeated here. The character setup information may include features such as the identity and personality of the target virtual character, as well as its current emotion and the feature of the intimacy parameter with the user. Therefore, when determining the interactive text, the consistency between the interactive text and the features of the target virtual character can be achieved based on the above parameters. In this case, the memory information may include the long-term memory, the current state, the surrounding environment, etc. of the target virtual character. Combining the above information can make the determined interactive text consistent with the historical performance of the target virtual character, thereby improving the matching degree when interacting with the user based on the interactive text, improving the user experience, and at the same time, it can also improve the personification level and personalized interaction of the target virtual character, and further improve the accuracy of controlling the virtual character.

In a possible embodiment, the memory information includes long-term memory information and short-term memory information, the long-term memory information includes the event information and the conversation information, and the short-term memory information includes a conversation context corresponding to the user. The above specific content has been described in detail above, and will not be repeated here.

Correspondingly, based on the character setup information, the interactive information, and the memory information, generating the interactive text corresponding to the target virtual character may include:
based on the interactive information, retrieving associated memory information corresponding to the interactive information from the long-term memory information, and adding the associated memory information to the conversation context.

As an example, the matching can be performed based on the interactive information and the long-term memory information. For example, the matching can be performed in a way of calculating the similarity of the feature vectors. When the similarity between the two is greater than a similarity threshold, the long-term memory information corresponding to the similarity may be considered as the associated memory information corresponding to the interactive information. The similarity threshold can be set based on an actual application scenario, which is not limited in the present disclosure.

Correspondingly, the interactive text may be generated subsequently based on the character setup information, the interactive information, and the short-term memory information.

In this embodiment, a prompt can be constructed based on the character setup information, the interactive information, and the short-term memory information, so as to generate the corresponding interactive text based on the LLM.

As an example, the short-term memory information may also include one or more from a group consisting of the current state information of the target virtual character, the environmental information of the currently located environment, and the basic plan. Therefore, when determining the interactive text, the above information can also be combined to generate the interactive text, so as to further improve the accuracy of the interactive text, avoid the occurrence of the interactive text that does not conform to the current features of the target virtual character, and improve the personification level of interacting with the user.

Therefore, with the above technical solutions, the memory information can be divided into long-term memory information and short-term memory information for separate storage, thereby avoiding the situation of excessive calculation amount caused by excessive memory data amount, and improving the efficiency of interactive text generation. In this case, when generating the interactive text, the associated memory information can be retrieved from the long-term memory information, so that the generation error of the interactive text caused by memory loss can be avoided to a certain extent, and at the same time, in combination with the character setup information, the personalized experience of the conversation interaction can also be improved.

In a possible embodiment, the character setup information includes immediate setup information for representing attribute information of the target virtual character that changes during an interaction process; the immediate setup information includes an intimacy parameter for representing an intimacy degree between the user and the target virtual character; and
accordingly, the method further includes:
based on the interactive text, determining an intimacy change value corresponding to the target virtual character and the user.

As an example, an intimacy analysis model can be pre-trained, and the currently determined interactive text can be input into the intimacy analysis model, so as to obtain the intimacy change value. The intimacy analysis model can be obtained by pre-training the conversation text and the intimacy change value labeled in the conversation text based on the neural network model, which will not be repeated here.

As another example, an intimacy adjustment rule can be pre-set, and after the interactive text is determined, rule matching can be performed based on the interactive text and the historical interactive text, so that the intimacy change value can be determined based on the matched rule, and a new intimacy value can be determined based on the current intimacy value and the intimacy change value. For example, when the current intimacy value is 90, after the interactive text is determined, rule matching is performed based on the interactive text, and the intimacy change value is determined based on the matched rule. For example, when the matched rule is that the interactive text does not meet the user's requirement, the change value −2 corresponding to this plan can be used as the intimacy change value. As shown in the conversation influence part in FIG. 2, the conversation influence part may include the influence on the intimacy.

As another example, generally, when a player chats with a virtual character, there may also be an emotional companionship requirement. In this embodiment, emotion recognition can be performed on the interactive text. When the recognized emotion is a positive emotion, it may indicate that the target virtual character has a relatively high degree of favorability for the user, and in this case, the intimacy can be increased. When the recognized emotion is a negative emotion, it may indicate that the target virtual character has a relatively low degree of favorability for the user, and in this case, the intimacy can be reduced. As an example, change values corresponding to increasing the intimacy and reducing the intimacy can be set respectively, and different change values may be set for different emotion levels.

Optionally, the intimacy change value can be determined separately based on the above-mentioned multiple methods, and the final intimacy change value can be obtained by weighted fusion. The weights of different methods can be pre-set based on an actual durable/general scenario, which is not limited here.

The intimacy parameter in the immediate setup information is updated based on the intimacy change value. For example, the sum of the intimacy parameter in the immediate setup information and the intimacy change value can be used as the new intimacy parameter in the immediate setup information to implement the update.

Therefore, in the process of the conversation between the user and the target virtual character, the update of the intimacy parameter can be implemented based on the interactive sample generated in the current round. Then, when the interactive text is generated in the next round, the text generation can be performed based on the updated intimacy parameter, so that the update of the intimacy parameter of the target virtual character and the user is implemented, and at the same time, accurate data support is provided for the subsequent generation of the interactive sample, thereby further improving the personification of the conversation of the target virtual character.

In a possible embodiment, the method may further include:
storing the interactive information and the interactive text in conversation information corresponding to the target virtual character and the user.

The interactive information between the user and the target virtual character may have an impact on a subsequent plan of the target virtual character. For example, when the target virtual character is a bakery clerk who is going to purchase raw materials tomorrow, when the user has a conversation with the target virtual character, the user tells the target virtual character that there is a discount activity in the supermarket S1 tomorrow, so that when generating a basic plan of the target virtual character for tomorrow based on the memory information subsequently, the interactive information provided by the user can be referred to for behavior generation. As shown in FIG. 2, the memory information may be updated based on the interaction between the user and the target virtual character.

In this embodiment, the storing can be performed separately for each user to generate a private memory of the target virtual character for each user. The conversation interactive text with the user may be saved for the target virtual character, that is, the interactive information input by the user and the interactive text corresponding to the target virtual character may be saved. The virtual character has different memories for different players, which can ensure the consistency of the conversation interaction between the target virtual character and the user when generating the interactive text subsequently, and at the same time, it can also provide more comprehensive and accurate data reference for the subsequent generation of the basic plan of the target virtual character, so that the user can influence the plot or behavior of the virtual character through the conversation.

In a possible embodiment, an exemplary implementation of outputting the interactive text may include:
based on the interactive text, determining expression information corresponding to the target virtual character when the target virtual character outputs the interactive text.

The expression information can be identified through a pre-trained emotion classification model, and the interactive text can be input into the emotion classification model to obtain the corresponding expression information. The emotion classification model may be obtained by training a neural network model with texts and expressions labeled corresponding to the texts, which will not be repeated here.

Controlling a facial expression of the target virtual character based on the expression information, and displaying the interactive text in the virtual scene interface and/or playing an interactive voice corresponding to the interactive text.

In this embodiment, a facial expression of the target virtual character can be driven to be displayed based on the expression information. In this case, the interactive text can be displayed in the form of a bubble, and/or a corresponding interactive voice can also be played. Optionally, a mouth shape of the target virtual character can also be driven to change based on the interactive text, which can be implemented by the related art of text-driven digital human mouth shape in the art.

Therefore, with the above technical solutions, when controlling the target virtual object to output the interactive text, a facial expression of the target virtual character can be further controlled to be displayed, so as to improve the expressiveness of the dialogue effect of the target virtual character, and further improve the personification and personalization of the target virtual character when having a conversation with the user.

In a possible embodiment, the method further includes:
determining whether the virtual scene includes an interactive virtual character that needs to perform a conversation interaction.

The user can interact with the virtual character, and different virtual characters can also be determined whether they want to interact with other virtual characters during the action process.

As an example, for the virtual character VA1 and the virtual character VA2, which are currently on the way to the supermarket, whether they interact can be determined based on the distance between them and the memory information. For example, when the distance between them is less than a distance threshold and the memory information includes the conversation memory of the two, it can be determined that the virtual character VA1 and the virtual character VA2 are interactive virtual characters that need to perform a conversation interaction. The identification and determination process is only an exemplary illustration and does not limit the present disclosure, and can be specifically configured based on an actual application scenario.

When there is the interactive virtual character(s), a conversation text corresponding to the interactive virtual character(s) is generated based on state information, character setup information, and memory information corresponding to the interactive virtual character(s), respectively, the conversation text includes an interactive text corresponding to the interactive virtual character(s), respectively; and

controlling the interactive virtual character(s) to perform a conversation interaction based on the conversation text.

A prompt can be constructed based on the state information, the character setup information, and the memory information corresponding to the virtual character VA1 and the virtual character VA2 respectively, so as to determine the corresponding conversation text based on the LLM model. As an example, the memory information may be obtained by summarizing a part about the virtual character VA2 in the memory information of the virtual character VA1 and a part about the virtual character VA1 in the memory information of the virtual character VA2.

As an example, the conversation text may be expressed as follows:
Virtual character VA1: Are you going to the S1 supermarket?
Virtual character VA2: Yes, there is a discount activity in the S1 supermarket.
Virtual character VA1: It just so happens that I want to buy more X1.
Virtual character VA2: Okay, let's go together.

Further, after the conversation text is determined, the interactive text corresponding to each interactive virtual character may be determined, and each interactive virtual object may be further controlled to output its corresponding interactive text in turn, so as to display the interaction process of the interactive virtual objects in the virtual scene.

Therefore, with the above technical solutions, in the process of controlling the virtual character based on the basic plan, the conversation interaction between different virtual characters can be generated in real time, thereby further improving the diversity of interaction.

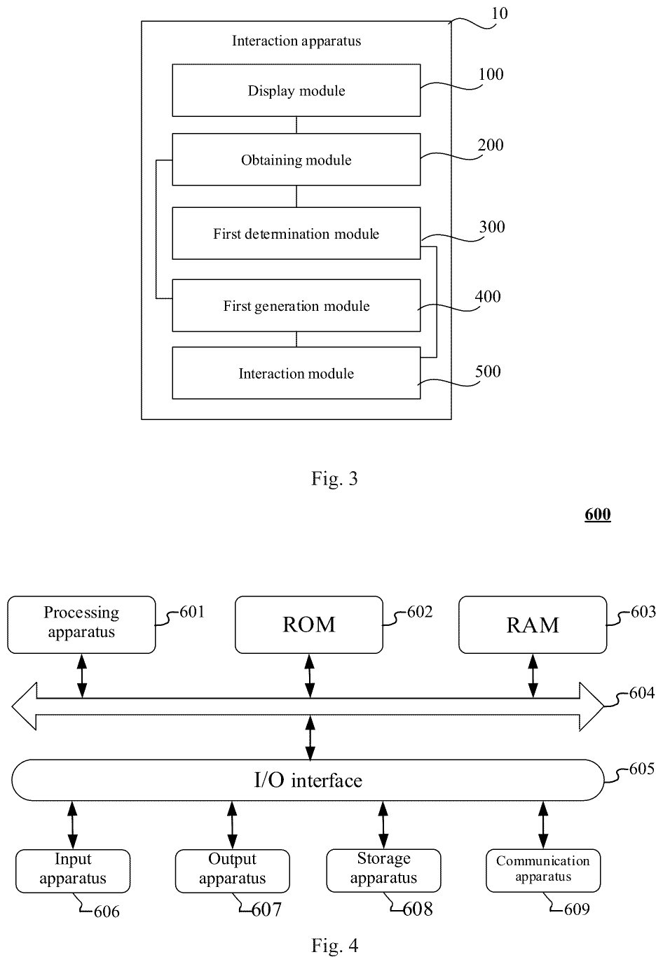

Based on the same inventive concept, the embodiments of the present disclosure further provide an interaction apparatus. As shown in FIG. 3, the apparatus 10 includes:
a display module 100, configured to display a virtual scene interface, in which the virtual scene interface includes at least one virtual character, actions of the virtual character are controlled based on a basic plan, the basic plan includes a basic instruction sequence corresponding to the virtual character;
an obtaining module 200, configured to, in response to an interactive operation of a user on a target virtual character in the virtual scene interface, acquire interactive information corresponding to the interactive operation;
a first determination module 300, configured to, based on the interactive information, determine a target instruction sequence corresponding to the target virtual character;
a first generation module 400, configured to, according to the interactive information and character information corresponding to the target virtual character, generate an interactive text corresponding to the target virtual character; and
an interaction module 500, configured to control the target virtual character to act based on the basic plan and the target instruction sequence, and output the interactive text.

Optionally, the first determination module includes:
a first determination sub-module, configured to identify the interactive information and determine whether the interactive information includes instruction information; and
a second determination sub-module, configured to, in response to the interactive information including the instruction information, determine the target instruction sequence based on the instruction information, a candidate virtual object in a target region where the target virtual character is located currently, and a candidate instruction corresponding to the candidate virtual object.

Optionally, the basic plan of the target virtual character is generated by:
acquiring character setup information of the target virtual character, and according to the character
setup information and a candidate position list corresponding to the target virtual character, generating various to-be-processed plans corresponding to the target virtual character;
acquiring the memory information of the target virtual character, and according to the memory information and the to-be-processed plans, generating a behavior of the target virtual character corresponding to each of the to-be-processed plans;
generating an instruction sequence corresponding to each of the behaviors, and splicing the instruction sequence based on time information corresponding to the behavior to obtain the basic plan.

Optionally, the character setup information includes basic setup information and immediate setup information, the basic setup information is used to represent attribute information of the target virtual character that is kept unchanged during an interaction process, and the immediate setup information is used to represent attribute information of the target virtual character that changes during an interaction process.

Optionally, the interaction module includes:
a first processing sub-module, configured to output the interactive text and determine a priority of a current instruction executed by the target virtual character in the basic plan and a priority of the target instruction sequence;
a first control sub-module, configured to, in response to the priority of the target instruction sequence being higher than the priority of the current instruction, control the target virtual character to execute an instruction in the target instruction sequence; and
a second control sub-module, configured to, after the instruction in the target instruction sequence is completed, control the target virtual character to execute the current instruction in the basic plan and an instruction after the current instruction.

Optionally, the interaction module includes:
a second processing sub-module, configured to output the interactive text and control the target virtual character to execute a target instruction in the target instruction sequence;
a first generation sub-module, configured to, based on character setup information and memory information of the target virtual character, generate a new basic plan corresponding to the target virtual character; and
a third control sub-module, configured to, after the instruction in the target instruction sequence is completed, control the target virtual character to execute an instruction in the new basic plan.

Optionally, the character information corresponding to the target virtual character includes character setup information and memory information of the target virtual character; and
the first generation module includes:
a second generation sub-module, configured to, based on the character setup information, the interactive information, and the memory information, generate an interactive text corresponding to the target virtual character, in which the memory information includes event information and conversation information of the target virtual character within a historical period of time.

Optionally, the memory information includes long-term memory information and short-term memory information, the long-term memory information includes event information and conversation information, and the short-term memory information includes a conversation context corresponding to the user; and
the second generation sub-module includes:
a retrieval sub-module, configured to, based on the interactive information, retrieve associated memory information corresponding to the interactive information from the long-term memory information, and add the associated memory information to the conversation context; and
a third generation sub-module, configured to, according to the character setup information, the interactive information, and the short-term memory information, generate the interactive text.

Optionally, the character setup information includes immediate setup information for representing attribute information of the target virtual character that changes during an interaction process; the immediate setup information includes an intimacy parameter for representing an intimacy degree between the user and the target virtual character; and
the apparatus further includes:
a second determination module, configured to, based on the interactive text, determine an intimacy change value corresponding to the target virtual character and the user; and
an update module, configured to update the intimacy parameter in the immediate setup information based on the intimacy change value.

Optionally, the apparatus further includes:
a storage module, configured to store the interactive information and the interactive text in conversation information corresponding to the target virtual character and the user.

Optionally, the interaction module includes:
a third determination sub-module, configured to, based on the interactive text, determine expression information corresponding to the target virtual character when the target virtual character outputs the interactive text; and
an interaction sub-module, configured to control a facial expression of the target virtual character based on the expression information, and display the interactive text in the virtual scene interface and/or play an interactive voice corresponding to the interactive text.

Optionally, the apparatus further includes:
a third determination module, configured to determine whether the virtual scene includes an interactive virtual character that needs to perform a conversation interaction;
a second generation module, configured to, in response to there being the interactive virtual character(s), generate a conversation text corresponding to the interactive virtual character(s) based on state information, character setup information, and memory information corresponding to the interactive virtual character(s), respectively, in which the conversation text includes an interactive text corresponding to the interactive virtual character(s), respectively; and
a control module, configured to control the interactive virtual character(s) to perform a conversation interaction on the basis of the conversation text.

Reference is made to FIG. 4 below, which illustrates a schematic structural diagram of an electronic device 600 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 4 is merely an example, and should not pose any limitation to the functions and the range of use of the embodiments of the present disclosure.

As illustrated in FIG. 4, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 508 into a random-access memory (RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 4 illustrates the electronic device 600 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display a virtual scene interface, in which the virtual scene interface includes at least one virtual character, actions of the virtual character are controlled based on a basic plan, the basic plan includes a basic instruction sequence corresponding to the virtual character; in response to an interactive operation of a user on a target virtual character in the virtual scene interface, acquire interactive information corresponding to the interactive operation; based on the interactive information, determine a target instruction sequence corresponding to the target virtual character; according to the interactive information and character information corresponding to the target virtual character, generate an interactive text corresponding to the target virtual character; and control the target virtual character to act based on the basic plan and the target instruction sequence, and output the interactive text.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the display module can also be described as a module that displays a virtual scene interface.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, Example 1 provides an interaction method, the method including:
displaying a virtual scene interface, in which the virtual scene interface includes at least one virtual character, actions of the virtual character are controlled based on a basic plan, the basic plan includes a basic instruction sequence corresponding to the virtual character;
in response to an interactive operation of a user on a target virtual character in the virtual scene interface, acquiring interactive information corresponding to the interactive operation;
based on the interactive information, determining a target instruction sequence corresponding to the target virtual character;
according to the interactive information and character information corresponding to the target virtual character, generating an interactive text corresponding to the target virtual character; and
controlling the target virtual character to act based on the basic plan and the target instruction sequence, and outputting the interactive text.

According to one or more embodiments of the present disclosure, Example 2 provides the method of Example 1, in which based on the interactive information, the determining the target instruction sequence corresponding to the target virtual character includes:
identifying the interactive information and determining whether the interactive information includes instruction information; and
in response to the interactive information including the instruction information, determining the target instruction sequence based on the instruction information, a candidate virtual object in a target region where the target virtual character is located currently, and a candidate instruction corresponding to the candidate virtual object.

According to one or more embodiments of the present disclosure, Example 3 provides the method of Example 1, in which the basic plan of the target virtual character is generated by:
acquiring character setup information of the target virtual character, and according to the character setup information and a candidate position list corresponding to the target virtual character, generating various to-be-processed plans corresponding to the target virtual character;
acquiring the memory information of the target virtual character, and according to the memory information and the to-be-processed plans, generating a behavior of the target virtual character corresponding to each of the to-be-processed plans;
generating an instruction sequence corresponding to each behavior, and splicing the instruction sequence based on time information corresponding to the behavior to obtain the basic plan.

According to one or more embodiments of the present disclosure, Example 4 provides the method of Example 3, in which the character setup information includes basic setup information and immediate setup information, the basic setup information is used to represent attribute information of the target virtual character that is kept unchanged during an interaction process, and the immediate setup information is used to represent attribute information of the target virtual character that changes during an interaction process.

According to one or more embodiments of the present disclosure, Example 5 provides the method of Example 1, in which controlling the target virtual character to act based on the basic plan and the target instruction sequence and outputting the interactive text includes:
outputting the interactive text and determining a priority of a current instruction executed by the target virtual character in the basic plan and a priority of the target instruction sequence;
in response to the priority of the target instruction sequence being higher than the priority of the current instruction, controlling the target virtual character to execute an instruction in the target instruction sequence; and
after the instruction in the target instruction sequence is completed, controlling the target virtual character to execute the current instruction in the basic plan and an instruction after the current instruction.

According to one or more embodiments of the present disclosure, Example 6 provides the method of Example 1, in which controlling the target virtual character to act based on the basic plan and the target instruction sequence and outputting the interactive text includes:
outputting the interactive text and controlling the target virtual character to execute a target instruction in the target instruction sequence;
based on the character setup information and the memory information of the target virtual character, generating a new basic plan corresponding to the target virtual character; and
after the instruction in the target instruction sequence is completed, controlling the target virtual character to execute an instruction in the new basic plan.

According to one or more embodiments of the present disclosure, Example 7 provides the method of Example 1, in which the character information corresponding to the target virtual character includes character setup information and memory information of the target virtual character; and
according to the interactive information and the character information corresponding to the target virtual character, generating the interactive text corresponding to the target virtual character includes:
based on the character setup information, the interactive information, and the memory information, generating the interactive text corresponding to the target virtual character, in which the memory information includes event information and conversation information of the target virtual character within a historical period of time.

According to one or more embodiments of the present disclosure, Example 8 provides the method of Example 7, in which the memory information includes long-term memory information and short-term memory information, the long-term memory information includes the event information and the conversation information, and the short-term memory information includes a conversation context corresponding to the user; and
based on the character setup information, the interactive information, and the memory information, the generating the interactive text corresponding to the target virtual character includes:
based on the interactive information, retrieving associated memory information corresponding to the interactive information from the long-term memory information, and adding the associated memory information to the conversation context; and
according to the character setup information, the interactive information, and the short-term memory information, generating the interactive text.

According to one or more embodiments of the present disclosure, Example 9 provides the method of Example 7, in which the character setup information includes immediate setup information for representing attribute information of the target virtual character that changes during an interaction process; the immediate setup information includes an intimacy parameter for representing an intimacy degree between the user and the target virtual character; and
the method further includes:
based on the interactive text, determining an intimacy change value corresponding to the target virtual character and the user; and
updating the intimacy parameter in the immediate setup information based on the intimacy change value.

According to one or more embodiments of the present disclosure, Example 10 provides the method of Example 7, the method further includes:
storing the interactive information and the interactive text in conversation information corresponding to the target virtual character and the user.

According to one or more embodiments of the present disclosure, Example 11 provides the method of Example 1, in which the outputting the interactive text includes:
based on the interactive text, determining expression information corresponding to the target virtual character when the target virtual character outputs the interactive text; and
controlling a facial expression of the target virtual character based on the expression information, and displaying the interactive text in the virtual scene interface and/or playing an interactive voice corresponding to the interactive text.

According to one or more embodiments of the present disclosure, Example 12 provides the method of Example 1, the method further includes:
determining whether the virtual scene includes an interactive virtual character that needs to perform a conversation interaction;
in response to there is the interactive virtual character(s), generating a conversation text corresponding to the interactive virtual character(s) based on state information, character setup information, and memory information corresponding to the interactive virtual character(s), respectively, in which the conversation text includes an interactive text corresponding to the interactive virtual character(s), respectively; and
controlling the interactive virtual character(s) to perform a conversation interaction based on the conversation text.

According to one or more embodiments of the present disclosure, Example 13 provides an interaction apparatus, the apparatus including:
a display module, configured to display a virtual scene interface, in which the virtual scene interface includes at least one virtual character, actions of the virtual character are controlled based on a basic plan, the basic plan includes a basic instruction sequence corresponding to the virtual character;
an obtaining module, configured to, in response to an interactive operation of a user on a target virtual character in the virtual scene interface, acquire interactive information corresponding to the interactive operation;
a first determination module, configured to, based on the interactive information, determine a target instruction sequence corresponding to the target virtual character;
a first generation module, configured to, according to the interactive information and character information corresponding to the target virtual character, generate an interactive text corresponding to the target virtual character; and
an interaction module, configured to control the target virtual character to act based on the basic plan and the target instruction sequence, and output the interactive text.

According to one or more embodiments of the present disclosure, Example 14 provides a computer-readable medium having a computer program stored thereon, which, when executed by a processing apparatus, implements the steps of any one of the interaction methods in Examples 1-12.

According to one or more embodiments of the present disclosure, Example 15 provides an electronic device, which includes:
a storage apparatus having a computer program stored thereon; and
a processing apparatus configured to execute the computer program in the storage apparatus to implement the steps of any one of the interaction methods in Examples 1-12.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. An interaction method, comprising:
displaying a virtual scene interface, wherein the virtual scene interface comprises at least one virtual character, actions of the virtual character are controlled based on a basic plan, the basic plan comprises a basic instruction sequence corresponding to the virtual character;
in response to an interactive operation of a user on a target virtual character in the virtual scene interface, acquiring interactive information corresponding to the interactive operation;
based on the interactive information, determining a target instruction sequence corresponding to the target virtual character;
according to the interactive information and character information corresponding to the target virtual character, generating an interactive text corresponding to the target virtual character; and
controlling the target virtual character to act based on the basic plan and the target instruction sequence, and outputting the interactive text.

2. The method according to claim 1, wherein based on the interactive information, the determining the target instruction sequence corresponding to the target virtual character comprises:
identifying the interactive information and determining whether the interactive information comprises instruction information; and
in response to the interactive information comprising the instruction information, determining the target instruction sequence based on the instruction information, a candidate virtual object in a target region where the target virtual character is currently located, and a candidate instruction corresponding to the candidate virtual object.

3. The method according to claim 1, wherein the basic plan of the target virtual character is generated by:
acquiring character setup information of the target virtual character, according to the character setup information and a candidate position list corresponding to the target virtual character, generating various to-be-processed plans corresponding to the target virtual character;
acquiring memory information of the target virtual character, according to the memory information and the to-be-processed plans, generating a behavior of the target virtual character corresponding to each of the to-be-processed plans; and
generating an instruction sequence corresponding to each behavior, and splicing the instruction sequence based on time information corresponding to the behavior to obtain the basic plan.

4. The method according to claim 3, wherein the character setup information comprises basic setup information and immediate setup information, the basic setup information is used to represent attribute information of the target virtual character that is kept unchanged during an interaction process, and the immediate setup information is used to represent attribute information of the target virtual character that changes during an interaction process.

5. The method according to claim 1, wherein the controlling the target virtual character to act based on the basic plan and the target instruction sequence and outputting the interactive text comprises:
outputting the interactive text and determining a priority of a current instruction executed by the target virtual character in the basic plan and a priority of the target instruction sequence;
in response to the priority of the target instruction sequence being higher than the priority of the current instruction, controlling the target virtual character to execute an instruction in the target instruction sequence; and
after the instruction in the target instruction sequence is completed, controlling the target virtual character to execute the current instruction in the basic plan and an instruction after the current instruction.

6. The method according to claim 1, wherein the controlling the target virtual character to act based on the basic plan and the target instruction sequence and outputting the interactive text comprises:
outputting the interactive text and controlling the target virtual character to execute a target instruction in the target instruction sequence;
based on the character setup information and the memory information of the target virtual character, generating a new basic plan corresponding to the target virtual character; and
after the instruction in the target instruction sequence is completed, controlling the target virtual character to execute an instruction in the new basic plan.

7. The method according to claim 1, wherein the character information corresponding to the target virtual character comprises character setup information and memory information of the target virtual character; and
according to the interactive information and character information corresponding to the target virtual character, the generating an interactive text corresponding to the target virtual character comprises:
based on the character setup information, the interactive information, and the memory information, generating the interactive text corresponding to the target virtual character, wherein the memory information comprises event information and conversation information of the target virtual character within a historical period of time.

8. The method according to claim 7, wherein the memory information comprises long-term memory information and short-term memory information, the long-term memory information comprises the event information and the conversation information, and the short-term memory information comprises a conversation context corresponding to the user; and
based on the character setup information, the interactive information, and the memory information, the generating the interactive text corresponding to the target virtual character comprises:
based on the interactive information, retrieving associated memory information corresponding to the interactive information from the long-term memory information, and adding the associated memory information to the conversation context; and
according to the character setup information, the interactive information, and the memory information, generating the interactive text.

9. The method according to claim 7, wherein the character setup information comprises immediate setup information for representing attribute information of the target virtual character that changes during an interaction process; the immediate setup information comprises an intimacy parameter for representing an intimacy degree between the user and the target virtual character; and
the method further comprises:
based on the interactive text, determining an intimacy change value corresponding to the target virtual character and the user; and
updating the intimacy parameter in the immediate setup information based on the intimacy change value.

10. The method according to claim 7, further comprising:
storing the interactive information and the interactive text in conversation information corresponding to the target virtual character and the user.

11. The method according to claim 1, wherein the outputting the interactive text comprises:
based on the interactive text, determining expression information corresponding to the target virtual character when the target virtual character outputs the interactive text; and
controlling a facial expression of the target virtual character based on the expression information, and displaying the interactive text in the virtual scene interface and/or playing an interactive voice corresponding to the interactive text.

12. The method according to claim 1, further comprising:
determining whether the virtual scene comprises an interactive virtual character that needs to perform a conversation interaction;
in response to there being the interactive virtual character, generating a conversation text corresponding to the interactive virtual character based on state information, character setup information, and memory information respectively corresponding to the interactive virtual character, wherein the conversation text comprises an interactive text corresponding to the interactive virtual character; and
controlling the interactive virtual character to perform a conversation interaction based on the conversation text.

13. A non-transitory computer-readable medium, having a computer program stored thereon, wherein the program, when executed by a processing apparatus, implements an interaction method, the method comprises:
displaying a virtual scene interface, wherein the virtual scene interface comprises at least one virtual character, actions of the virtual character are controlled based on a basic plan, the basic plan comprises a basic instruction sequence corresponding to the virtual character;
in response to an interactive operation of a user on a target virtual character in the virtual scene interface, acquiring interactive information corresponding to the interactive operation;
based on the interactive information, determining a target instruction sequence corresponding to the target virtual character;
according to the interactive information and character information corresponding to the target virtual character, generating an interactive text corresponding to the target virtual character; and
controlling the target virtual character to act based on the basic plan and the target instruction sequence, and outputting the interactive text.

14. An electronic device, comprising:
a storage apparatus, having a computer program stored thereon; and
a processing apparatus, configured to execute the computer program in the storage apparatus to:
display a virtual scene interface, wherein the virtual scene interface comprises at least one virtual character, actions of the virtual character are controlled based on a basic plan, the basic plan comprises a basic instruction sequence corresponding to the virtual character;
in response to an interactive operation of a user on a target virtual character in the virtual scene interface, acquire interactive information corresponding to the interactive operation;
based on the interactive information, determine a target instruction sequence corresponding to the target virtual character;
according to the interactive information and character information corresponding to the target virtual character, generate an interactive text corresponding to the target virtual character; and
control the target virtual character to act based on the basic plan and the target instruction sequence, and output the interactive text.

15. The electronic device according to claim 14, wherein the processing apparatus is further to:
identify the interactive information and determine whether the interactive information comprises instruction information; and
in response to the interactive information comprising the instruction information, determine the target instruction sequence based on the instruction information, a candidate virtual object in a target region where the target virtual character is currently located, and a candidate instruction corresponding to the candidate virtual object.

16. The electronic device according to claim 14, wherein the basic plan of the target virtual character is generated by:
acquiring character setup information of the target virtual character, according to the character setup information and a candidate position list corresponding to the target virtual character, generating various to-be-processed plans corresponding to the target virtual character;
acquiring memory information of the target virtual character, according to the memory information and the to-be-processed plans, generating a behavior of the target virtual character corresponding to each of the to-be-processed plans; and
generating an instruction sequence corresponding to each behavior, and splicing the instruction sequence based on time information corresponding to the behavior to obtain the basic plan.

17. The electronic device according to claim 16, wherein the character setup information comprises basic setup information and immediate setup information, the basic setup information is used to represent attribute information of the target virtual character that is kept unchanged during an interaction process, and the immediate setup information is used to represent attribute information of the target virtual character that changes during an interaction process.

18. The electronic device according to claim 14, wherein the processing apparatus is further to:
output the interactive text and determining a priority of a current instruction executed by the target virtual character in the basic plan and a priority of the target instruction sequence;
in response to the priority of the target instruction sequence being higher than the priority of the current instruction, control the target virtual character to execute an instruction in the target instruction sequence; and
after the instruction in the target instruction sequence is completed, control the target virtual character to execute the current instruction in the basic plan and an instruction after the current instruction.

19. The electronic device according to claim 14, wherein the processing apparatus is further to:
output the interactive text and controlling the target virtual character to execute a target instruction in the target instruction sequence;
based on the character setup information and the memory information of the target virtual character, generate a new basic plan corresponding to the target virtual character; and
after the instruction in the target instruction sequence is completed, control the target virtual character to execute an instruction in the new basic plan.

20. The electronic device according to claim 14, wherein the character information corresponding to the target virtual character comprises character setup information and memory information of the target virtual character; and
the processing apparatus is further to:
based on the character setup information, the interactive information, and the memory information, generate the interactive text corresponding to the target virtual character, wherein the memory information comprises event information and conversation information of the target virtual character within a historical period of time.
